(19) United States
(12) Patent Application Publication
(10) Pub. No.: US 2017/0171616 A1
(43) Pub. Date: Jun. 15, 2017

(54) CONTROL OF UNSUITABLE VIDEO CONTENT

(71) Applicant: Sasken Communication Technologies Ltd, Bangalore (IN)

(72) Inventor: Milind Pathak, Bangalore (IN)

(73) Assignee: Sasken Communication Technologies Ltd, Bangalore (IN)

(21) Appl. No.: 15/130,970

(22) Filed: Apr. 16, 2016

(30) Foreign Application Priority Data
Dec. 11, 2015 (IN) 6649/CHE/2015

(51) Int. Cl. H04N 21/454; H04N 5/44; H04N 21/472; H04N 21/44; H04N 21/422; H04N 21/45

(52) U.S. Cl. CPC H04N 21/454; H04N 21/42204; H04N 21/4532; H04N 21/47217; H04N 21/44008; H04N 5/4403; H04N 2005/4412

(57) ABSTRACT

A method for controlling a display of unsuitable video content is described. The method provides for control of any unsuitable video content as perceived by the user and display of alternative video content of user's choice, at the press of a dedicated button, on a remote controller, of a device controlling the video display. The original video stream may be resumed by a second press of the same dedicated button on the remote controller. The method includes a provision for alternative ways of programming alternative video content in the device that controls the video display. When multiple options for alternative video content exist, a choice may be configured through the settings of the device controlling the video display. The method also provides for resumption of original video content, by the press of the said button on a remote controller or by the expiry of a timer configured through settings of the device controlling the video display system. Incorporation of the control of unsuitable video content in multiple devices controlling the video display, in various scenarios, is described.

### TECHNICAL FIELD

Embodiments herein relate to a control of display of a video broadcast content depending on a perception of a user over a suitability of the video broadcast content for an audience. The present application is based on, and claims priority from an Indian Application Number 6649/CHE/2015 filed on 11 Dec. 2015, the disclosure of which is hereby incorporated by reference herein.

### BACKGROUND

Video content is broadcasted over many channels from several content providers. Users, typically, subscribe to one content provider from several content providers and make a choice of channels that users wish to view. The video content may contain adult content, depiction of violence etc, which are typically considered unsuitable video content. While some channels having definite unsuitable content could be filtered in making the choice of the channels to view, the presence of unsuitable content in the chosen channels may still exist and would be intermittent. For instance, a violent scene in a movie may be filtered when children are watching the movie. Also, perception of unsuitable content is subjective and may be temporal, may depend on the composition of the audience, mood of the viewer or other factors. Unsuitable video content may exist even in stored video.

One of the simplest manner for filtering video content exercised by the users is by switching the channel through a remote controller. However, such a switching may not guarantee that the new channel chosen does not have unsuitable content at the same time. Many methods have been proposed for the control of display of video content, by a user. The methods in the prior art, typically, allow users to define unsuitable content by specifying certain elements such as violence and adult content, through a pre-defined menu. Once the settings are done, the video content is analyzed for the presence of the specified elements by an automated method and, when detected, the user is alerted or the display is blanked out. When the user is alerted the user could make a choice to continue viewing or blanking out the display.

However, the existing approaches fail in providing an intelligence of an accurate and automated detection of the specified elements that are unsuitable. Also the perception of unsuitable content is very subjective. The perception depends on the audience, mood, time and several such factors, at the instant of viewing.

Another limitation of the existing approaches for the control of unsuitable video content is that such existing approaches blank out the display and/or continue rendering the audio. Rendering the audio may not be acceptable.

Yet another limitation of the existing approaches is that they address the issue of filtering unsuitable content only in specific scenarios; the approaches do not address the universal space of scenarios.

In Summary, more creative alternatives to control of unsuitable video content could be explored.

### SUMMARY

In view of the foregoing, the invention herein discloses a method of controlling the display of unsuitable video content, where the video content subsumes an audio content associated with the video content, wherein a user perceives unsuitable video content and replaces it by pre-programmed suitable content by pressing a dedicated button the remote controller of any device in the reception path that supports the replacement of the unsuitable video content.

The alternative video content may be a blank screen, still image, animation or a video of user's choice. The alternative content may be pre-loaded into the device controlling the video display, by the manufacturer of the device controlling the video display, for the convenience of the user. Optionally, the alternative content may be loaded into the device controlling the video display, by the user. The alternative content to be displayed is configured through the setting of the device controlling the video display.

The duration of the display of the alternative video content is determined by the follow-on press of the dedicated button on the remote controller on the remote controller of the device controlling the video display. Alternatively, the duration of display of the alternative content may be configured through the setting of the device controlling the video display.

The feature of display of alternative video content may be made available on a variety of devices to address all scenarios needing the feature. For instance, one embodiment of a device controlling the video display may be a passive display device, such as a TV or monitor. Another embodiment of a device controlling the video display may be a smart display device, such as a SmartTV. Yet another embodiment of a device controlling the video display is a STB or an accessory like Google TV, Apple TV, DVD or BlueRay player.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings. The embodiments of the invention are illustrated by way of examples, and not by way of limitation, by the accompanying drawings, in which:

FIG. 1a illustrates a block diagram of broadcast video viewed on a display device, such as a TV 102, wherein the broadcast video is received directly from an antenna 104 in accordance with an embodiment of the disclosure;

FIG. 1b illustrates the block diagram of the broadcast video viewed on the display device, such as a TV 102, wherein the broadcast video is received through a STB (or Accessory) 106, the STB (or Accessory) 106 not capable of recording the video, in accordance with an embodiment of the disclosure;

FIG. 1c illustrates the block diagram of stored video viewed on the display device, such as a TV 102, wherein the stored video is received through a STB (or Accessory) 106, the STB (or Accessory) 106 not capable of recording the video, in accordance with an embodiment of the disclosure;

FIG. 1d illustrates the block diagram of broadcast video viewed on the display device, such as a SmartTV 108, wherein the broadcast video is received directly from an antenna 104, in accordance with an embodiment of the disclosure;

FIG. 1e illustrates the block diagram of streaming video viewed on a display device, such as a SmartTV 108, in accordance with an embodiment of the disclosure;

FIG. 1f illustrates the block diagram of stored video viewed on a display device, such as a SmartTV 108, received through a STB (or Accessory) 106, the STB (or Accessory) 106 not capable of recording the video, in accordance with an embodiment of the disclosure;

FIG. 2 illustrates an embodiment of the control of unsuitable content in scenarios where video is viewed on a display device, such as a TV, received directly from an antenna or through a STB not supporting recording, where the alternative content is a color screen, without an automated timer for resumption of original video;

FIG. 3 illustrates an embodiment of the control of unsuitable content in scenarios where the video is viewed on the display device, such as a TV, received directly from an antenna or through a STB not supporting recording, where the alternative content is a color screen, with an automated timer for resumption of original video;

FIG. 4 illustrates an embodiment of the control of unsuitable content in scenarios where the video is viewed on the display device, such as the TV, received directly from an antenna or through a STB not supporting recording, where the alternative content is a still image, without an automated timer for resumption of original video;

FIG. 5 illustrates an embodiment of the control of unsuitable content in scenarios where the video is viewed on the display device, such as the TV, received directly from an antenna or through a STB not supporting recording, where the alternative content is a still image, with an automated timer for resumption of original video;

FIG. 6 illustrates an embodiment of the control of the unsuitable content in scenarios where the video is viewed on the display device, such as the TV, received directly from an antenna or through a STB not supporting recording, where the alternative content is an animation, without an automated timer for resumption of original video;

FIG. 7 illustrates an embodiment of the control of unsuitable content in scenarios where the video is viewed on the display device, such as the TV, received directly from an antenna or through a STB not supporting recording, where the alternative content is an animation, with an automated timer for resumption of original video;

FIG. 8 illustrates an embodiment of the control of unsuitable content in scenarios where the video is viewed on the display device, such as a TV, received directly from an antenna or through a STB not supporting recording, where the alternative content is a video playback, without an automated timer for resumption of original video;

FIG. 9 illustrates an embodiment of the control of unsuitable content in scenarios where the video is viewed on the display device, such as the TV, received directly from the antenna or through the STB not supporting recording, where the alternative content is a video playback, with an automated timer for resumption of original video;

FIG. 10a illustrates the block diagram of broadcast video viewed on the display device, such as the TV 102, the broadcast video received through an STB (or Accessory) 1002, capable of recording the video, in accordance with an embodiment of the disclosure;

FIG. 10b illustrates the block diagram of broadcast video viewed on the display device, such as the TV 102, the stored video received through the STB (or Accessory) 1002, the STB (or Accessory) 1002 capable of recording the broadcast video simultaneously, in accordance with an embodiment of the disclosure, and FIG. 10c illustrates the block diagram of stored video viewed on the display device 102;

FIG. 10d illustrates the block diagram of stored video viewed on the display device, such as the SmartTV 108, the stored video received through the STB (or Accessory) 1002, the STB (or Accessory) 1002 capable of recording the broadcast video simultaneously, in accordance with an embodiment of the disclosure;

FIG. 11 illustrates an embodiment of the control of unsuitable content in scenarios where video is viewed on the display device, such as the TV, received through the smart device, such as the SmartTV or STB, which support video recording, where the alternative video content is a color screen, without an automated timer for resumption of original video;

FIG. 12 illustrates an embodiment of the control of unsuitable content in scenarios where the video is viewed on the display device, such as the TV, received through the smart device, such as the SmartTV or STB, which support video recording, where the alternative video content is a color screen, with an automated timer for resumption of original video;

FIG. 13 illustrates an embodiment of the control of unsuitable content in scenarios where the video is viewed on the display device, such as the TV, received through the smart device, such as the SmartTV or STB, which support video recording where the alternative video content is a still image, without an automated timer for resumption of original video;

FIG. 14 illustrates an embodiment of the control of unsuitable content in scenarios where video is viewed on the display device, such as the TV, received through a smart device, such as a SmartTV or STB, which support video recording, where the alternative video content is a still image, with an automated timer for resumption of original video;

FIG. 15 illustrates an embodiment of the control of unsuitable content in scenarios where the video is viewed on the display device, such as the TV, received through the smart device, such as the SmartTV or STB, which support video recording where the alternative video content is an animation, without an automated timer for resumption of original video;

FIG. 16 illustrates an embodiment of the control of unsuitable content in scenarios where the video is viewed on the display device, such as a TV, received through the smart device, such as the SmartTV or STB, which support video recording, where the alternative video content is an animation, with an automated timer for resumption of original video;

FIG. 17 illustrates an embodiment of the control of unsuitable content in scenarios where the video is viewed on the display device, such as the TV, received through the smart device, such as the SmartTV or STB, which support video recording, where the alternative video content is a video playback, without an automated timer for resumption of original video;

FIG. 18 illustrates an embodiment of the control of unsuitable content in scenarios where the video is viewed on the display device, such as a TV, received through the smart device, such as the SmartTV or STB, which support video recording where the alternative video content is a video playback, with an automated timer for resumption of original video.

### DETAILED DESCRIPTION OF EMBODIMENTS

The embodiments herein and the various features and advantages thereof are explained more fully with reference to the non-limiting embodiments that are illustrated in the accompanying drawings and detailed in the following description. Descriptions of well-known components and processing techniques are omitted so as to not unnecessarily obscure the embodiments herein.

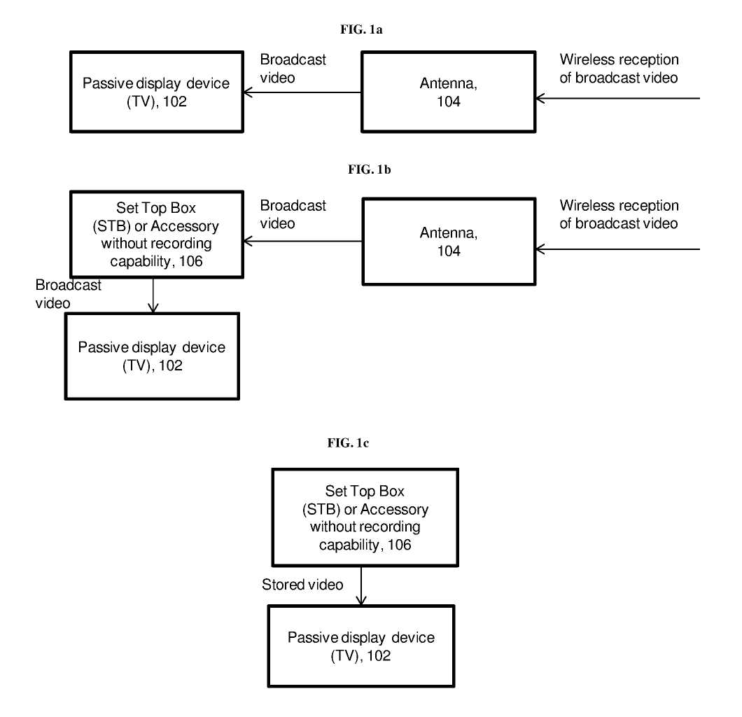

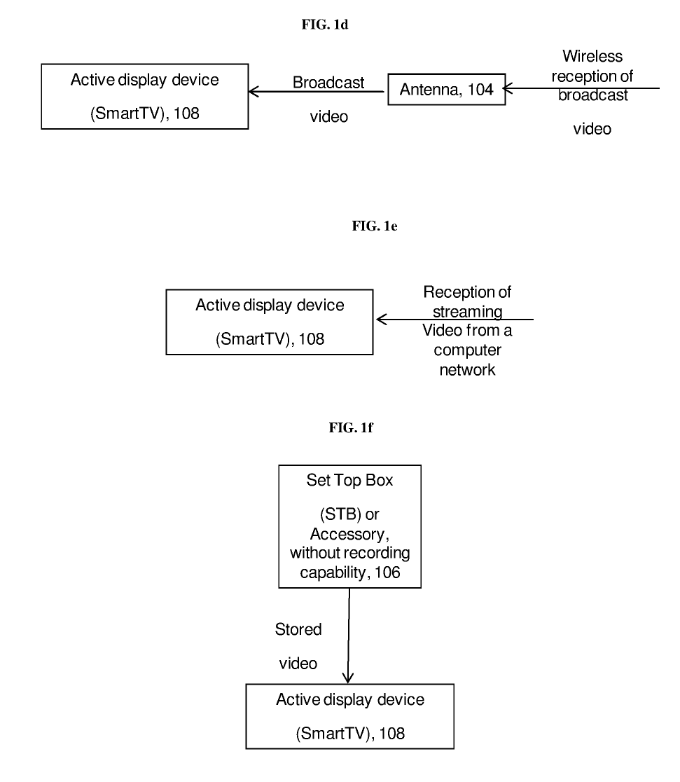

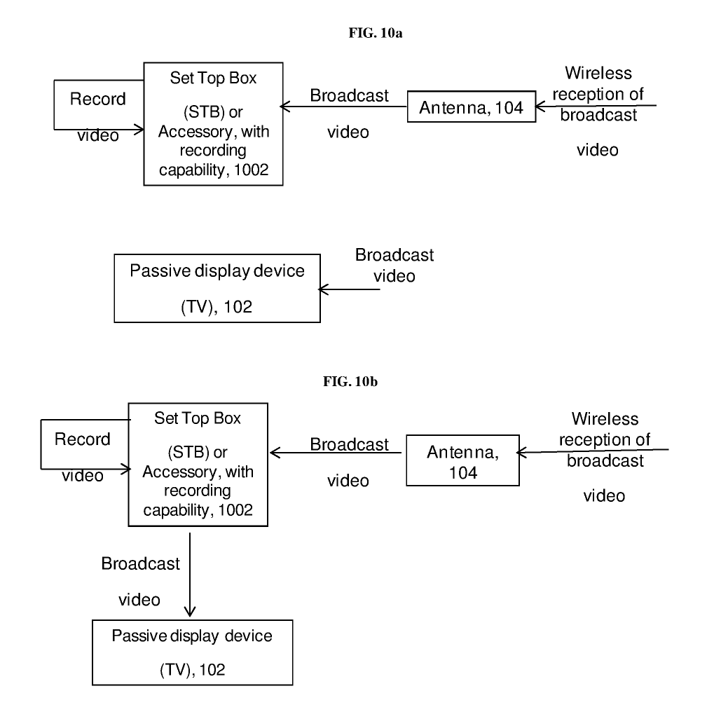

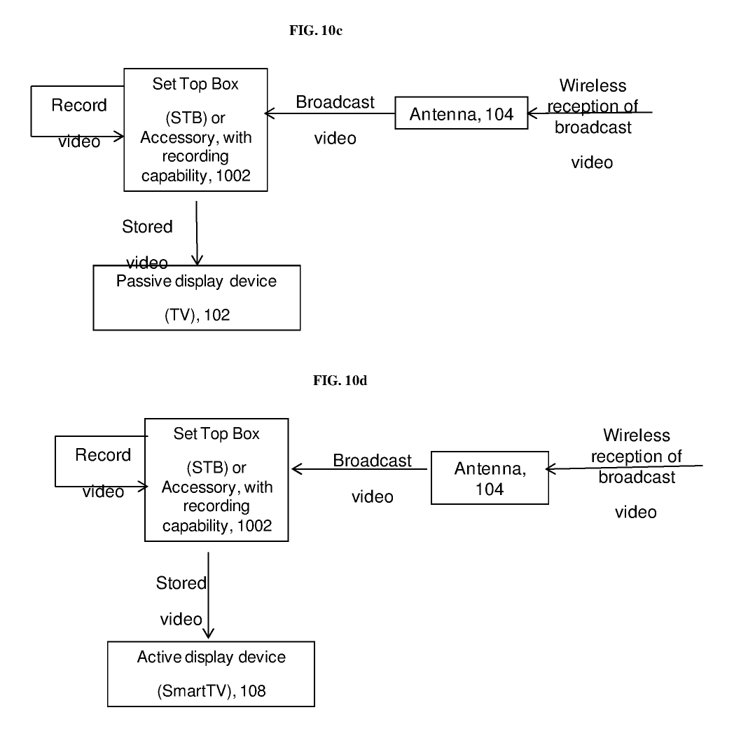

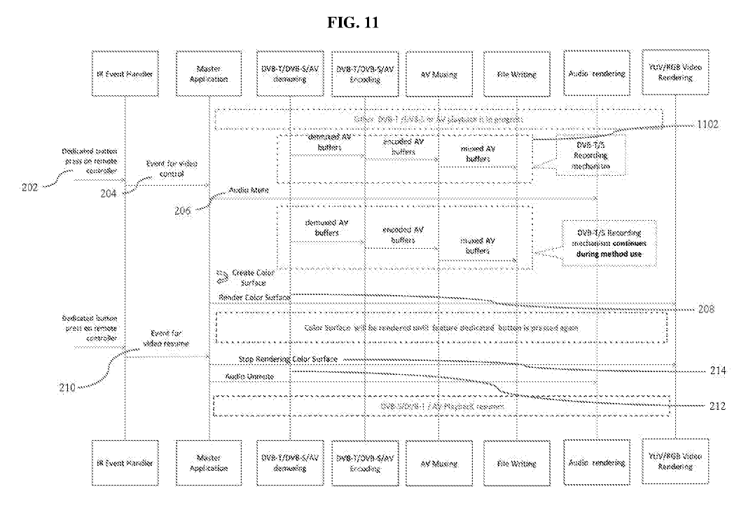

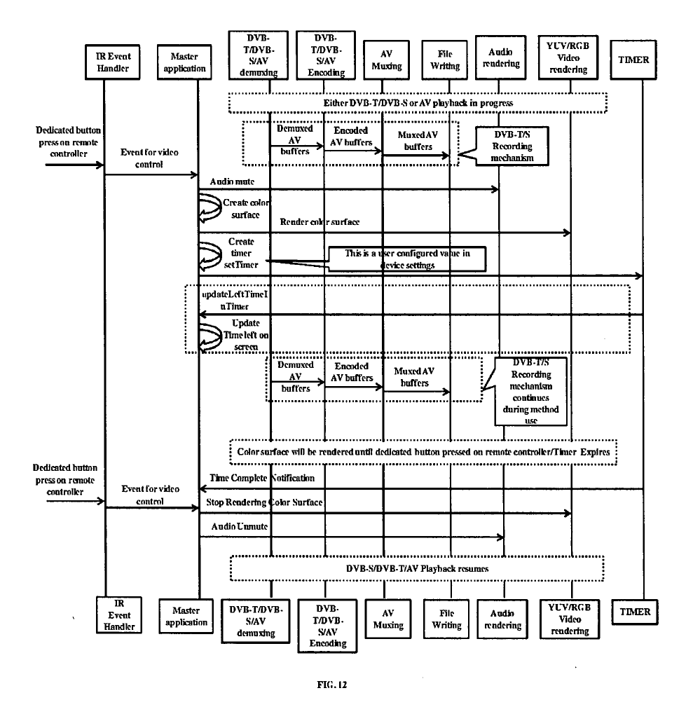

The embodiments herein disclose a method for control of unsuitable video content, in various scenarios, involving various devices, with the display of various alternative video contents. Unsuitable video content could be adult content, violent content or any content perceived to be objectionable by a user. The various scenarios in which unsuitable video content may arise as briefly described in FIGS. 1a to 1f and FIGS. 10a to 10d. Various devices on which support for replacement of unsuitable video content by alternative content is dependent on the scenarios of FIGS. 1a to 1f and FIGS. 10a to 10d and is detailed as these scenarios are described in the rest of this section. The various alternative forms of video contents described are a blank screen, color screen, a still image, an animation, and a full fledged video.

The key aspects of the description are provision for control of any video content perceived as unsuitable, rather than some pre-programmed description of unsuitable video content, and display of alternative with its associated video; the audio and video of the original video stream are replaced. Referring now to the drawings, and more particularly to FIG. 1 through FIG. 18, where similar reference numbers denote same features consistently throughout the figures, the sample embodiments are described below.

The examples used herein are intended merely to facilitate an understanding of ways in which the embodiments herein may be practiced. Accordingly, the examples should not be construed as limiting the scope of the embodiments herein.

FIGS. 1a to 1f illustrate some typical scenarios of video viewing, where the video content is not recorded, as detailed in the description of the drawings. The video content may be received through a broadcast or from a stored content device. The video content may be displayed by a passive display device or a smart display device. The video content may be routed through an STB or displayed directly by the display device.

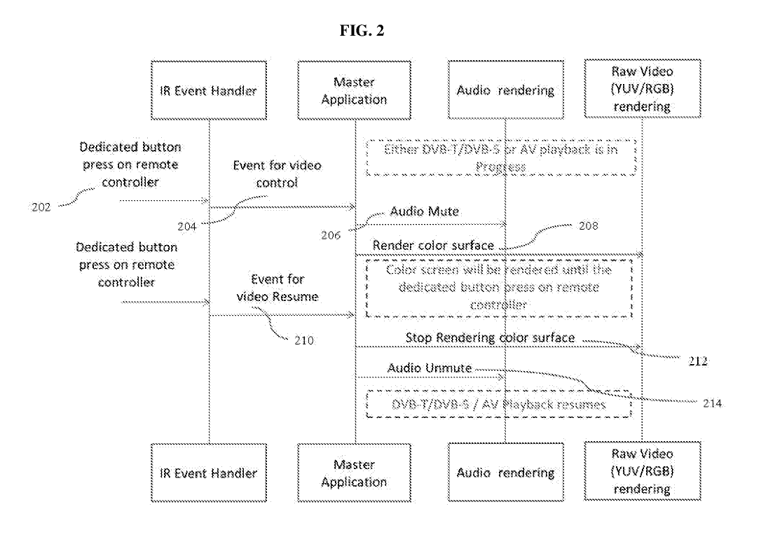

FIG. 2 illustrates an embodiment of the method in a scenario where video content is being received by a display device, such as a TV 102, from either an antenna 104 or from a playback device, such as an STB 106. The STB 106 is not capable of simultaneously recording the video received from the antenna 104, while it is being displayed on the TV 102.

FIG. 2 embodies the scenario illustrated in FIG. 1a and where a color screen is displayed on the TV 102, as alternative video content. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then generates a color screen and renders it 208 on the TV 102. The display of the color screen continues till the dedicated button 202 is pressed a second time on the remote controller of the TV 102. The second press of the dedicated button generates an event 210 to the master application on the TV 102. The master application responds to 210 by unmuting 212 the audio and terminating the display of color screen 214 on the TV 102. At this point, the original video stream, either from the antenna 104 or STB 106 resumes on the TV 102.

FIG. 2 also subsumes the scenarios illustrated in FIG. 1b as well as FIG. 1c and where the color screen is generated by the STB 106. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 2 also subsumes the scenarios illustrated in FIG. 1d, FIG. 1e as well as FIG. 1f and where the color screen is generated by an active display unit, such as a SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

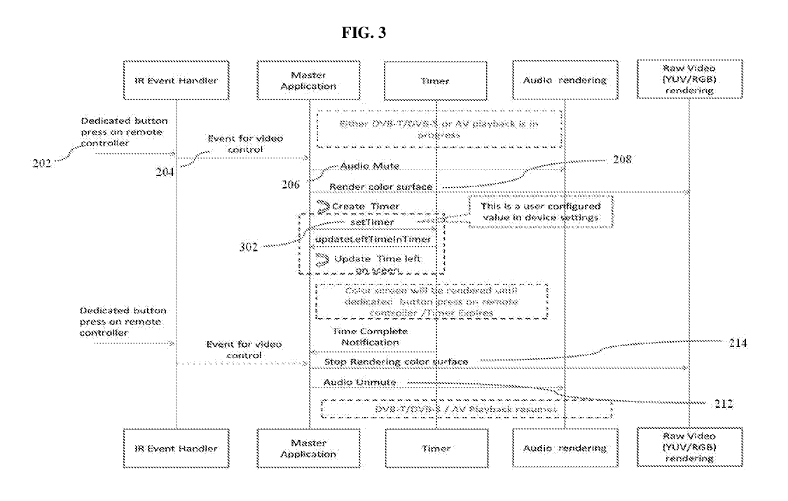

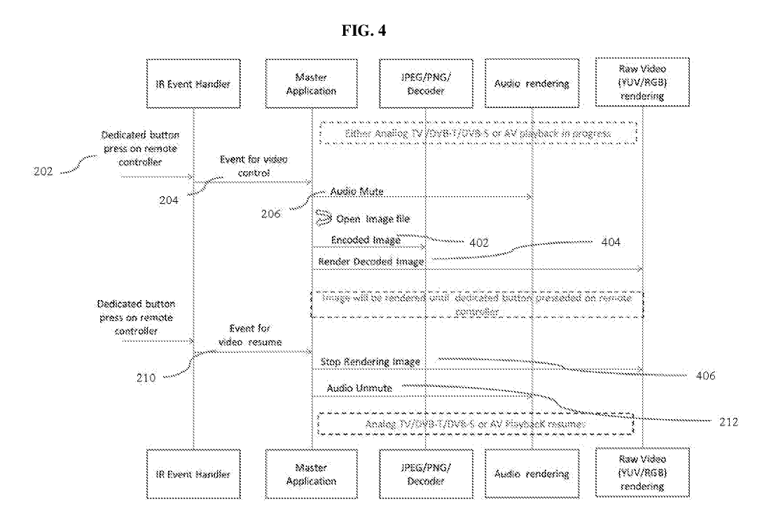

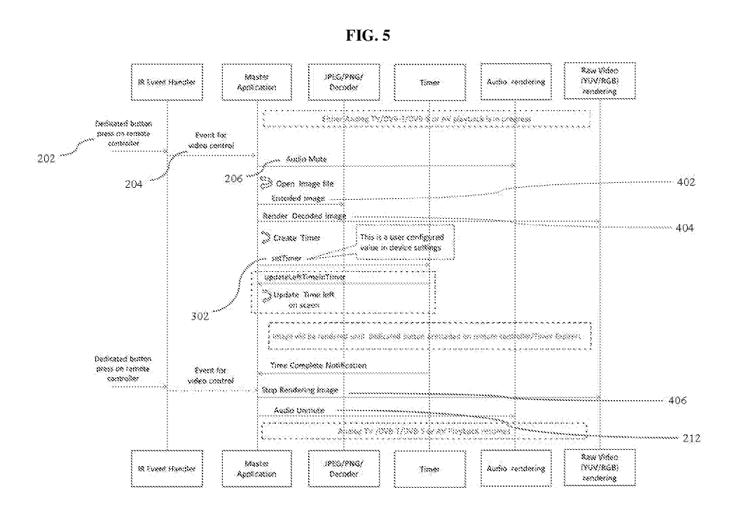

FIG. 3 illustrates an embodiment of the method in a scenario where video content is being received by a display device, such as a TV 102, from at least one of an antenna 104 and from a playback device, such as an STB 106. The STB 106 is not capable of simultaneously recording the video received from the antenna 104, while it is being displayed on the TV 102.

FIG. 3 embodies the scenario illustrated in FIG. 1a and where a color screen is displayed on the TV 102, as alternative video content, with the provision for an automated timer control. The TV 102 or the STB 106 is capable of running a timer. The user browses through the settings of the device and turns on a timer associated with the control of unsuitable video content. The user also sets a timer value 302. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then generates a color screen and renders it 208 on the TV 102. Subsequently, the master application checks if the timer has been configured for the control of unsuitable video content.

If the timer is configured, then the value of the timer is displayed on the TV 102. The timer is updated regularly at suitable intervals, such as a second. The display of the color screen continues till the dedicated button 202 is pressed a second time on the remote controller of the TV 102 or the timer 302 expires, wherein an interrupt event 210 is sent to the master application on the TV 102. The master application responds to 210 by clearing the timer display, unmuting 212 the audio and terminating the display of color screen 214 on the TV 102. At this point, the original video stream, either from the antenna 104 or STB 106 resumes on the TV 102.

FIG. 3 also subsumes the scenario illustrated in FIG. 1b as well as FIG. 1c and where the color screen and timer are generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 3 also subsumes the scenarios illustrated in FIG. 1d, FIG. 1e as well as FIG. 1f and where the color screen and timer generated by the active display unit, such as a SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 4 illustrates an embodiment of the method in a scenario where video content is being received by a display device, such as a TV 102, from either an antenna 104 or from a playback device, such as an STB 106. The STB 106 is not capable of simultaneously recording the video received from the antenna 104, while it is being displayed on the TV 102.

FIG. 4 embodies the scenario illustrated in FIG. 1a and where a still image is displayed on the TV 102, as alternative video content. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then transfers 402 an encoded image to an image codec. The decoded image is transferred back to the master application. The master application renders 404 the still image on the TV 102. The display of the still image continues till the dedicated button 202 is pressed a second time on the remote controller of the TV 102. The second press of the dedicated button generates an event 210 to the master application on the TV 102. The master application responds to 210 by unmuting 212 the audio and terminating the display of still image 406 on the TV 102. At this point, the original video stream, either from the antenna 104 or STB 106 resumes on the TV 102.

FIG. 4 also subsumes the scenario illustrated in FIG. 1b and FIG. 1c and where the still image is generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 4 also subsumes the scenarios illustrated in FIG. 1d, FIG. 1e as well as FIG. 1f and where the still image is generated by an active display unit, such as a SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 5 illustrates an embodiment of the said method in a scenario where the video content is being received by the display device, such as a TV 102, from at least one of the antenna 104 and the play back device, such as an STB 106. The STB 106 is not capable of simultaneously recording the video received from the antenna 104, while it is being displayed on the TV 102. FIG. 5 embodies the scenario illustrated in FIG. 1a and where a still image is displayed on the TV 102, as alternative video content, with the provision for an automated timer control. The TV 102 or the STB 106 is capable of running a timer. The user browses through the settings of the device and turns on the timer associated with the control of unsuitable video content. The user also sets the timer value 302. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then transfers 402 an encoded image to an image codec. A decoded image is transferred back to the master application. The master application renders 404 the still image on the TV 102. The display of the still image continues till the dedicated button 202 is pressed a second time on the remote controller of the TV 102 or the timer 302 expires, wherein an interrupt event 210 is sent to the master application on the TV 102. The master application responds to 210 by clearing the timer display, unmuting 212 the audio and terminating the display of the still image 406 on the TV 102. At this point, the original video stream, from at least one of the antenna 104 and STB 106 resumes on the TV 102.

FIG. 5 also subsumes the scenario illustrated in FIG. 1b as well as FIG. 1c and where the still image and timer generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 5 also subsumes the scenarios illustrated in FIG. 1d, FIG. 1e as well as FIG. 1f and where the still image and timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

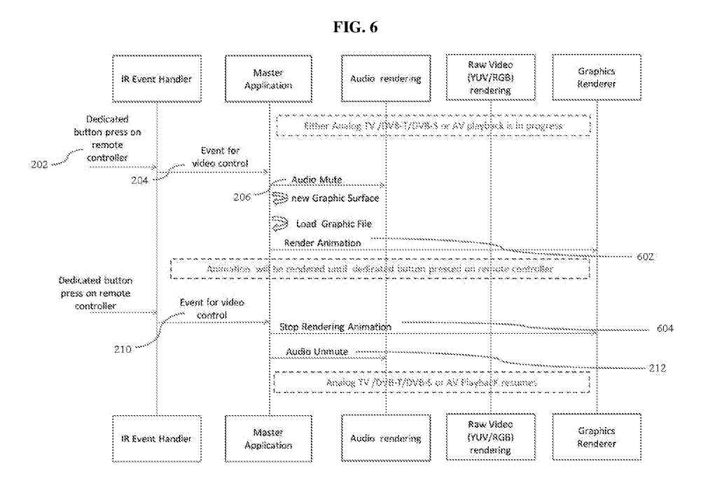

FIG. 6 illustrates an embodiment of the said method in a scenario where the video content is being received by the display device, such as the TV 102, from at least one of the antenna 104 and the playback device, such as the STB 106. The STB 106 is not capable of simultaneously recording the video received from the antenna 104, while it is being displayed on the TV 102. FIG. 6 embodies the scenario illustrated in FIG. 1a and where an animation is displayed on the TV 102, as alternative video content. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then decodes the encoded animation file. The decoded animation is transferred 602 to a graphics renderer. The graphics renderer displays the animation on the TV 102. The display of the animation continues till the dedicated button 202 is pressed a second time on the remote controller of the TV 102. The second press of the dedicated button generates an event 210 to the master application on the TV 102. The master application responds to 210 by unmuting 212 the audio and terminating the display of the animation 604 on the TV 102. At this point, the original video stream, either from the antenna 104 or STB 106 resumes on the TV 102.

FIG. 6 also subsumes the scenario illustrated in FIG. 1b as well as FIG. 1c and where the animation is generated by the STB 206. The method is commenced with the remote controller of the STB 106. In this case, the master application that responds to all events, such as the pressing of the dedicated button 202 and responding to event 204, is resident on the STB 106. All the actions described in the above paragraph are performed by the master application on the STB 106.

FIG. 6 also subsumes the scenarios illustrated in FIG. 1d, FIG. 1e as well as FIG. 1f and where the animation is generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

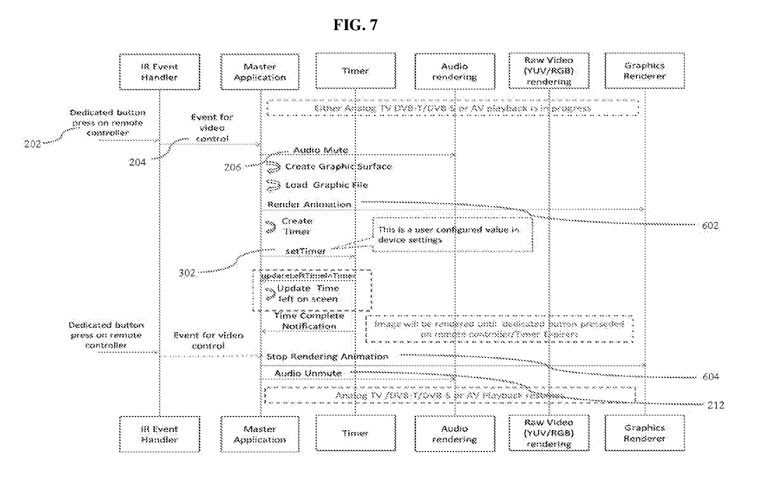

FIG. 7 illustrates an embodiment of the said method in a scenario where the video content is being received by the display device, such as the TV 102, from at least one of the antenna 104 and the play back device, such as the STB 106. The STB 106 is not capable of simultaneously recording the video received from the antenna 104, while it is being displayed on the TV 102. FIG. 7 embodies the scenario illustrated in FIG. 1a and where an animation is displayed on the TV 102, as alternative video content, with the provision for an automated timer control. The TV 102 or the STB 106 is capable of running a timer. The user browses through the settings of the device and turns on a timer associated with the control of unsuitable video content. The user also sets a timer value 302. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then decodes the encoded animation file. The decoded animation is transferred 602 to a graphics renderer. The graphics renderer displays the animation on the TV 102. The display of the animation continues till the dedicated button 202 is pressed a second time on the remote controller of the TV 102 or the timer 302 expires, wherein an interrupt event 210 is sent to the master application on the TV 102. The master application responds to 210 by clearing the timer display, unmuting 212 the audio and terminating the display of the animation 604 on the TV 102. At this point, the original video stream, either from the antenna 104 or STB 106 resumes on the TV 102.

FIG. 7 also subsumes the scenario illustrated in FIG. 1b as well as FIG. 1c and where the animation and the timer generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 7 also subsumes the scenarios illustrated in FIG. 1d, FIG. 1e as well as FIG. 1f and where the animation and timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

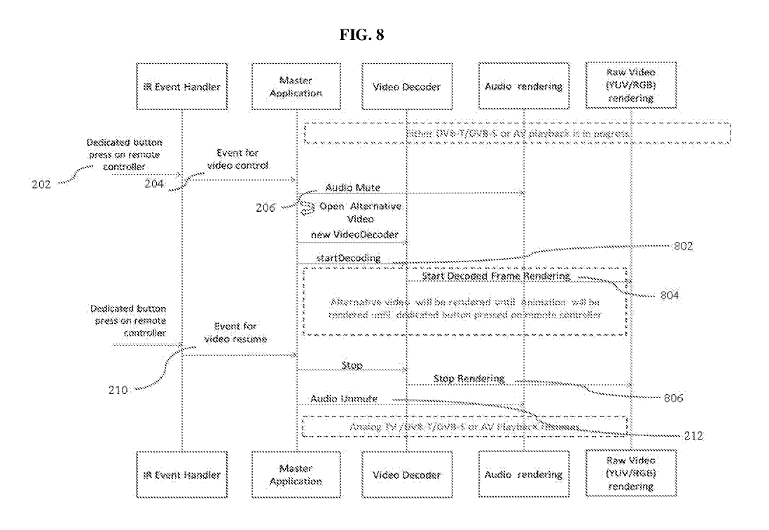

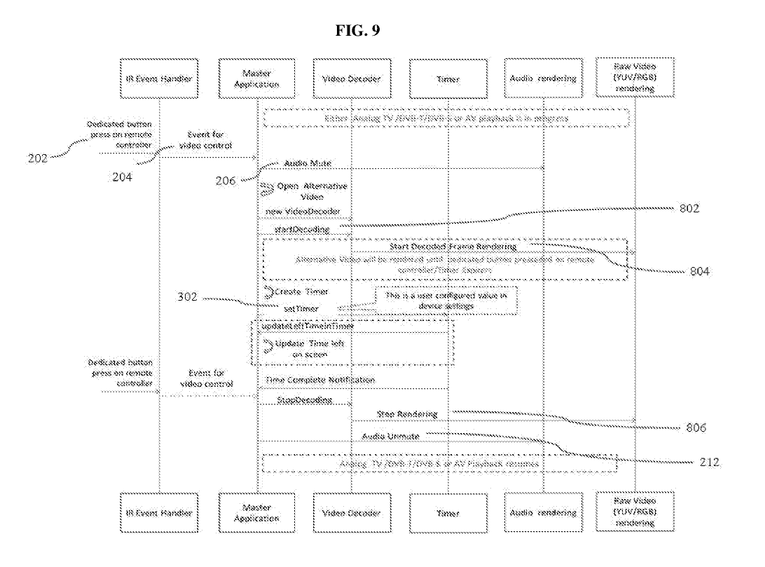

FIG. 8 illustrates an embodiment of the said method in a scenario where the video content is being received by the display device, such as the TV 102, from at least one of the antenna 104 and the playback device, such as the STB 106. The STB 106 is not capable of simultaneously recording the video received from the antenna 104, while it is being displayed on the TV 102. FIG. 8 embodies the scenario illustrated in FIG. 1a and where a full fledged video is displayed on the TV 102, as alternative video content. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then transfers 802 the encoded video to a video codec. The video decoder renders 804 the decoded video on the TV 102. The display of the alternative video continues till the dedicated button 202 is pressed a second time on the remote controller of the TV 102. The second press of the dedicated button generates an event 210 to the master application on the TV 102. The master application responds to 210 by unmuting 212 the audio and terminating the display of the alternative video 806 on the TV 102. At this point, the original video stream, either from the antenna 104 or STB 106 resumes on the TV 102.

FIG. 8 also subsumes the scenario illustrated in FIG. 1b as well as FIG. 1c and where the full fledged video is generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 8 also subsumes the scenarios illustrated in FIG. 1d, FIG. 1e as well as FIG. 1f and where the full fledged video is generated by an active display unit, such as a SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 9 illustrates an embodiment of the said method in a scenario where video content is being received by the display device, such as the TV 102, from at least one of the antenna 104 and from the play back device, such as the STB 106. The STB 106 is not capable of simultaneously recording the video received from the antenna 104, while it is being displayed on the TV 102. FIG. 9 embodies the scenario illustrated in FIG. 1a and where a full fledged video is displayed on the TV 102, as alternative video content, with the provision for an automated timer control. The TV 102 or the STB 106 is capable of running the timer. The user browses through the settings of the device and turns on the timer associated with the control of unsuitable video content. The user also sets the timer value 302. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then transfers 802 an encoded video to the video codec. The video decoder renders 804 the decoded video on the TV 102. The display of the alternative video continues till the dedicated button 202 is pressed the second time on the remote controller of the TV 102 or the timer 302 expires, wherein an interrupt event 210 is sent to the master application on the TV 102. The master application responds to 210 by clearing the timer display, unmuting 212 the audio and terminating the display of the alternative video 806 on the TV 102. At this point, the original video stream, at least from the antenna 104 and the STB 106 resumes on the TV 102.

FIG. 9 also subsumes the scenario illustrated in FIG. 1b as well as FIG. 1c and where the full fledged video and timer are generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 9 also subsumes the scenarios illustrated in FIG. 1d, FIG. 1e as well as FIG. 1f and where the full fledged video and timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 10a to 10d illustrate some typical scenarios of video viewing, where the video content is recorded, as detailed in the description of the drawings. The video content may be received through a broadcast or from a stored content device. The video content may be displayed by a passive display device or a smart display device. The video content may be routed through an STB or displayed directly by the display device.

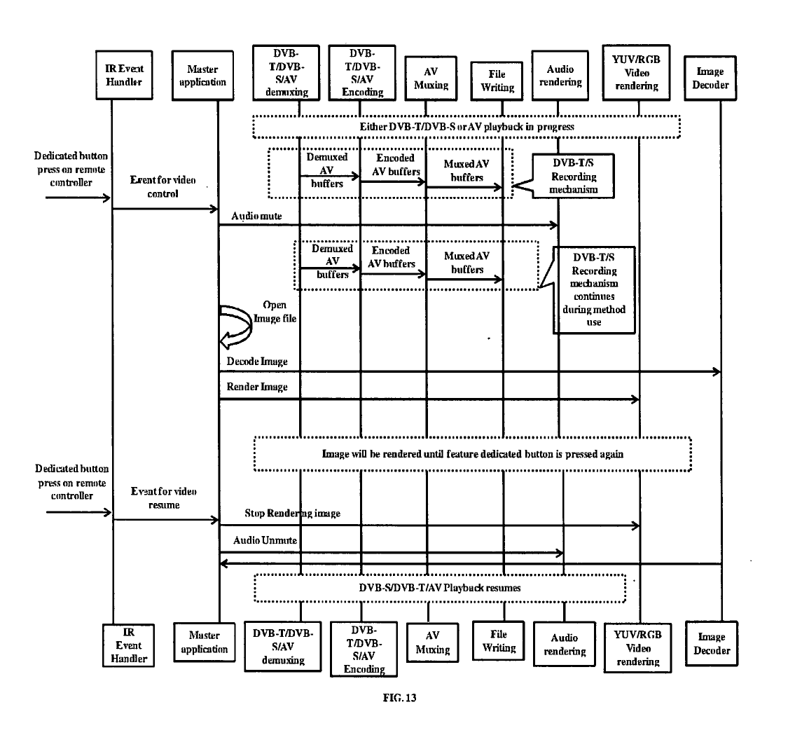

FIG. 11 illustrates an embodiment of the said method in a scenario where video content is being received by the display device, such as the TV 102, from at least one of the antenna 104 and from the playback device, such as the STB 106. The STB 106 is capable of simultaneously recording the video received from the antenna 104, while it is being displayed on the TV 102. FIG. 11 embodies the scenario illustrated in FIG. 10a and where a color surface is displayed on the TV 102, as alternative video content. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then generates a color screen and renders it 208 on the TV 102. If the STB was recording the original video content, then it continues to demux, decode, encode, mux and write 1102 the original video stream to a storage device. The display of the color screen continues till the dedicated button 202 is pressed a second time on the remote controller of the TV 102. The second press of the dedicated button generates an event 210 to the master application on the TV 102. The master application responds to 210 by unmuting 212 the audio and terminating the display of the color screen 214 on the TV 102. At this point, the original video stream, either from the antenna 104 or STB 106 resumes on the TV 102.

FIG. 11 also subsumes the scenario illustrated in FIG. 10b as well as FIG. 10c and where the color screen is generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 11 also subsumes the scenarios illustrated in FIG. 10c as well as FIG. 10d and where the color screen is generated by an active display unit, such as a SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

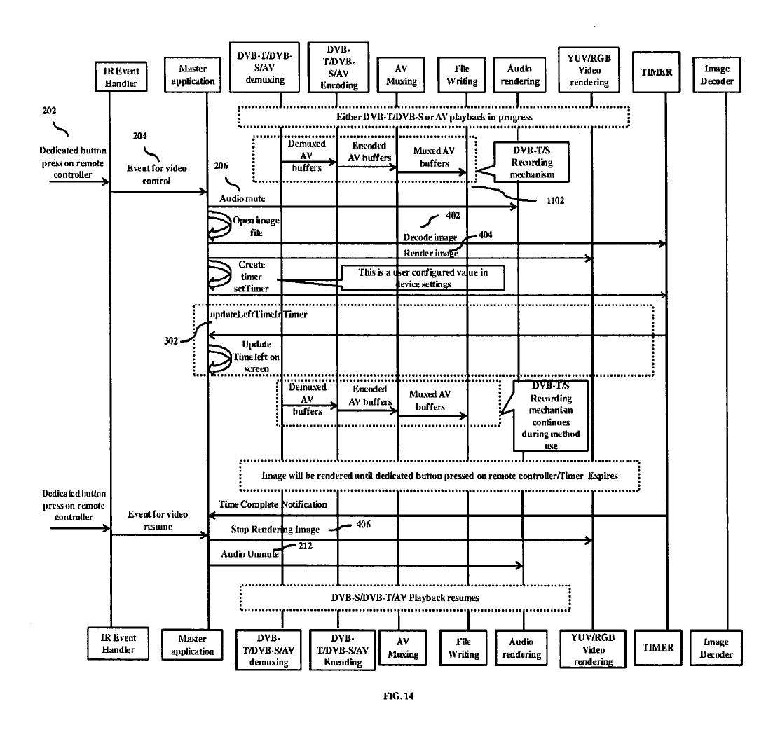

FIG. 12 illustrates an embodiment of the said method in a scenario where video content is being received by a display device, such as the TV 102, from at least one of the antenna 104 and the play back device, such as the STB 106. The STB 106 is capable of simultaneously recording the video received from the antenna 104, while it is being displayed on the TV 102. FIG. 12 embodies the scenario illustrated in FIG. 10a and where a color screen is displayed on the TV 102, as alternative video content, with the provision for an automated timer control. The TV 102 or the STB 106 is capable of running a timer. The user browses through the settings of the device and turns on the timer associated with the control of unsuitable video content. The user also sets the timer value 302. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then generates a color screen and renders it 208 on the TV 102. If the STB was recording the original video content, then it continues to demux, decode, encode, mux and write 1102 the original video stream to a storage device. The display of the color screen continues till the dedicated button 202 is pressed a second time on the remote controller of the TV 102 or the timer 302 expires, wherein an interrupt event 210 is sent to the master application on the TV 102. The master application responds to 210 by clearing the timer display, unmuting 212 the audio and terminating the display of the color screen 214 on the TV 102. At this point, the original video stream, either from the antenna 104 or STB 106 resumes on the TV 102.

FIG. 12 also subsumes the scenario illustrated in FIG. 10b as well as FIG. 10c and where the color screen and timer are generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 12 also subsumes the scenarios illustrated in FIG. 10c as well as FIG. 10d and where the color screen and timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 13 illustrates an embodiment of the said method in a scenario where video content is being received by a display device, such as the TV 102, from at least one of the antenna 104 and the playback device, such as the STB 106. The STB 106 is capable of simultaneously recording the video received from the antenna 104, while it is being displayed on the TV 102. FIG. 13 embodies the scenario illustrated in FIG. 10a and where a still image is displayed on the TV 102, as alternative video content. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then transfers 402 the encoded image to the image codec. The decoded image is transferred back to the master application. The master application renders 404 the still image on the TV 102. If the STB was recording the original video content, then it continues to demux, decode, encode, mux and write 1102 the original video stream to a storage device. The display of the still image continues till the dedicated button 202 is pressed a second time on the remote controller of the TV 102. The second press of the dedicated button generates an event 210 to the master application on the TV 102. The master application responds to 210 by unmuting 212 the audio and terminating the display of the still image 406 on the TV 102. At this point, the original video stream, either from the antenna 104 or STB 106 resumes on the TV 102.

FIG. 13 also subsumes the scenario illustrated in FIG. 10b as well as FIG. 10c and where the still image is generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 13 also subsumes the scenarios illustrated in FIG. 10c as well as FIG. 10d and where the still image is generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 14 illustrates an embodiment of the said method in a scenario where video content is being received by a display device, such as the TV 102, from at least one of the antenna 104 and the play back device, such as the STB 106. The STB 106 is capable of simultaneously recording the video received from the antenna 104, while it is being displayed on the TV 102. FIG. 14 embodies the scenario illustrated in FIG. 10a and where a still image is displayed on the TV 102, as alternative video content, with the provision for an automated timer control. The TV 102 or the STB 106 is capable of running a timer. The user browses through the settings of the device and turns on the timer associated with the control of unsuitable video content. The user also sets the timer value 302. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then transfers 402 an encoded image to an image codec. The decoded image is transferred back 404 to the master application. The master application renders 208 the still image on the TV 102. If the STB was recording the original video content, then it continues to demux, decode, encode, mux and write 1102 the original video stream to a storage device. The display of the color screen continues till the dedicated button 202 is pressed a second time on the remote controller of the TV 102 or the timer 302 expires, wherein an interrupt event 210 is sent to the master application on the TV 102. The master application responds to the event 210 by clearing the timer display, unmuting 212 the audio and terminating the display of the still image 1302 on the TV 102. At this point, the original video stream, either from the antenna 104 or the STB 106 resumes on the TV 102.

FIG. 14 also subsumes the scenario illustrated in FIG. 10b as well as FIG. 10c and where the still image and the timer are generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 14 also subsumes the scenarios illustrated in FIG. 10c as well as FIG. 10d and where the still image and timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

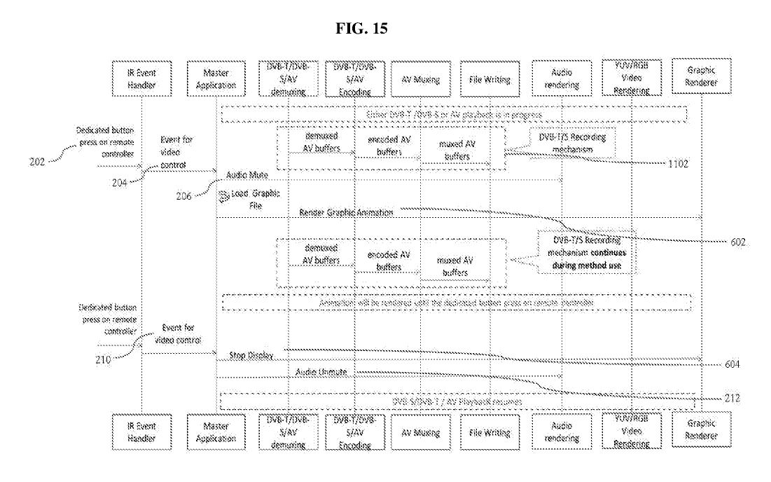

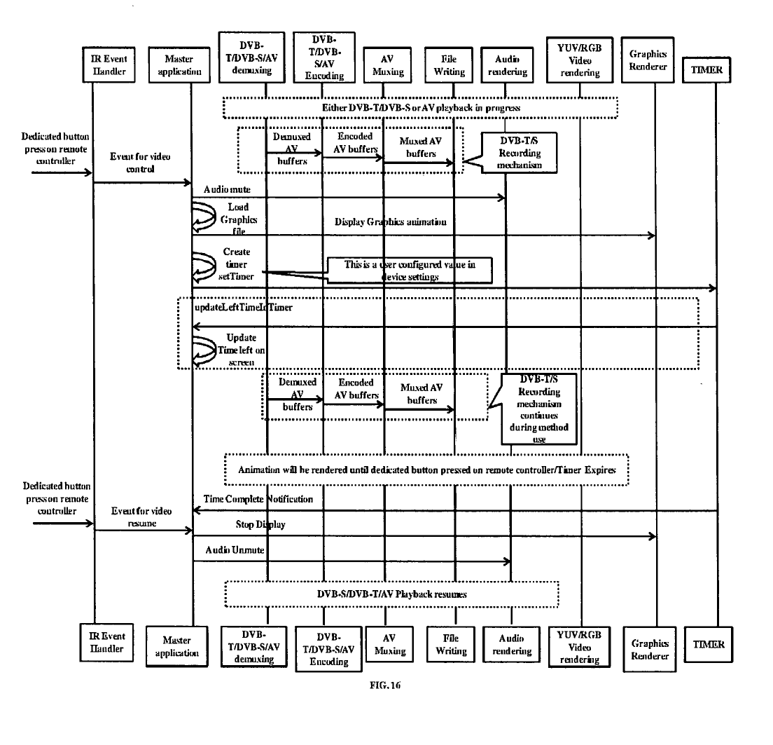

FIG. 15 illustrates an embodiment of the said method in a scenario where video content is being received by the display device, such as the TV 102, from at least one of the antenna 104 and from the playback device, such as the STB 106. The STB 106 is capable of simultaneously recording the video received from the antenna 104, while it is being displayed on the TV 102. FIG. 15 embodies the scenario illustrated in FIG. 10a and where the animation is displayed on the TV 102, as the alternative video content. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then decodes the encoded animation file. The decoded animation is transferred 602 to the graphics renderer. The graphics renderer displays the animation on the TV 102. If the STB was recording the original video content, then it continues to demux, decode, encode, mux and write 1102 the original video stream to a storage device. The display of the animation continues till the dedicated button 202 is pressed a second time on the remote controller of the TV 102. The second press of the dedicated button generates an event 210 to the master application on the TV 102. The master application responds to 210 by unmuting 212 the audio and terminating the display of the animation 604 on the TV 102. At this point, the original video stream, either from the antenna 104 or STB 106 resumes on the TV 102.

FIG. 15 also subsumes the scenario illustrated in FIG. 10b as well as FIG. 10c and where the animation is generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 15 also subsumes the scenarios illustrated in FIG. 10c as well as FIG. 10d and where the animation is generated by an active display unit, such as a SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 16 illustrates an embodiment of the said method in a scenario where video content is being received by the display device, such as the TV 102, from at least one of the antenna 104 and the play back device, such as the STB 106. The STB 106 is capable of simultaneously recording the video received from the antenna 104, while it is being displayed on the TV 102. FIG. 16 embodies the scenario illustrated in FIG. 10a and where the animation is displayed on the TV 102, as the alternative video content, with the provision for an automated timer control. The TV 102 or the STB 106 is capable of running the timer. The user browses through the settings of the device and turns on the timer associated with the control of unsuitable video content. The user also sets the timer value 302. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then decodes the encoded animation file. The decoded animation is transferred 602 to the graphics renderer. The graphics renderer displays the animation on the TV 102. If the STB was recording the original video content, then it continues to demux, decode, encode, mux and write 1102 the original video stream to a storage device. The display of the animation continues till the dedicated button 202 is pressed a second time on the remote controller of the TV 102 or the timer 302 expires, wherein an interrupt event 210 is sent to the master application on the TV 102. The master application responds to 210 by clearing the timer display, unmuting 212 the audio and terminating the display of the animation 604 on the TV 102. At this point, the original video stream, at least one of the antenna 104 and STB 106 resumes on the TV 102.

FIG. 16 also subsumes the scenario illustrated in FIG. 10b as well as FIG. 10c and where the animation and timer are generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 16 also subsumes the scenarios illustrated in FIG. 10c as well as FIG. 10d and where the animation and the timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

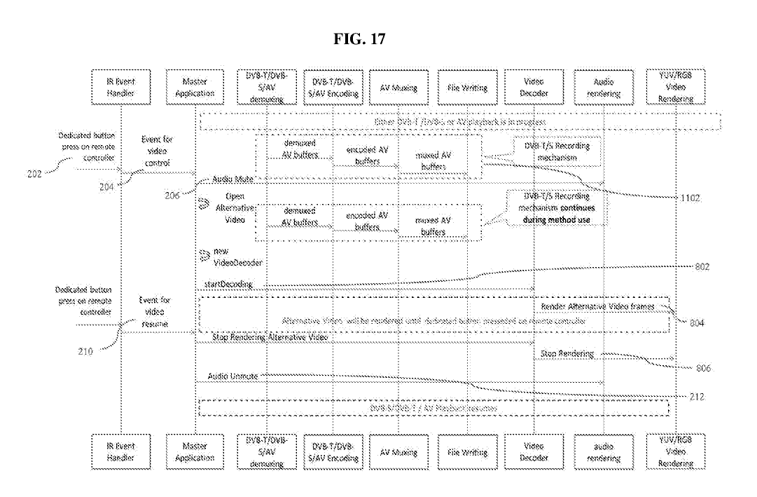

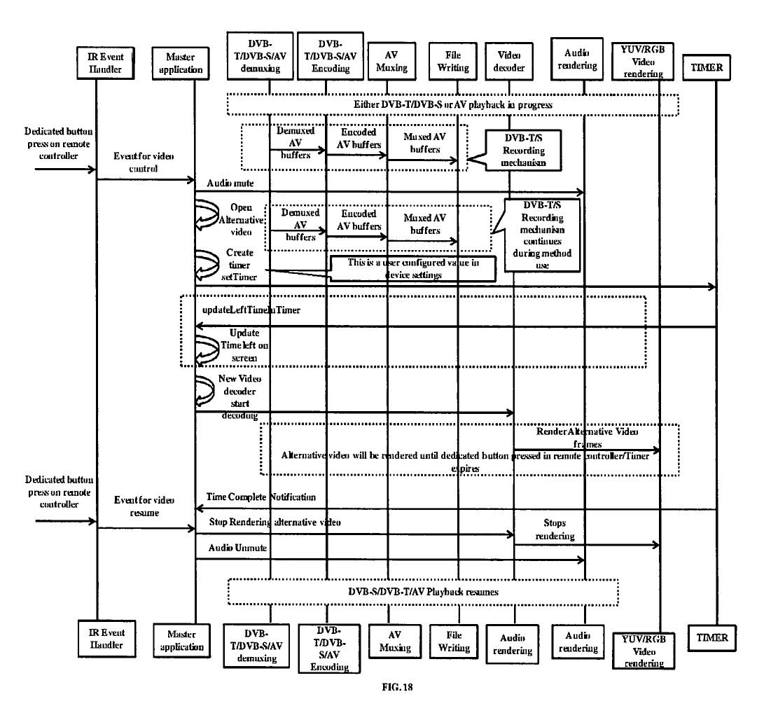

FIG. 17 illustrates an embodiment of the said method in a scenario where video content is being received by a display device, such as a TV 102, from either an antenna 104 or from a playback device, such as the STB 106. The STB 106 is capable of simultaneously recording the video received from the antenna 104, while it is being displayed on the TV 102. FIG. 17 embodies the scenario illustrated in FIG. 10a and where a full fledged video is displayed on the TV 102, as alternative video content. On perceiving unsuitable video content, the user presses a dedicated button 202 on the remote controller of the TV 102, wherein an interrupt event 204 is sent to the master application on the TV 102. The master application responds to the event 204 by muting 206 the audio. The master application then transfers 802 the encoded video to a video codec. The video decoder renders 804 the decoded video on the TV 102. If the STB was recording the original video content, then it continues to demux, decode, encode, mux and write 1102 the original video stream to a storage device. The display of the alternative video continues till the dedicated button 202 is pressed the second time on the remote controller of the TV 102. The second press of the dedicated button generates an event 210 to the master application on the TV 102. The master application responds to 210 by unmuting 212 the audio and terminating the display of the alternative video 806 on the TV 102. At this point, the original video stream, either from the antenna 104 or STB 106 resumes on the TV 102.

FIG. 17 also subsumes the scenario illustrated in FIG. 10b as well as FIG. 10c and where the full fledged video is generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 17 also subsumes the scenarios illustrated in FIG. 10c as well as FIG. 10d and where the full fledged video is generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

FIG. 18 illustrates an embodiment of the said method in a scenario where video content is being received by the display device, such as the TV 102, from at least one of the antenna 104 and from the play back device, such as the STB 106. The STB 106 is capable of simultaneously recording the video received from the antenna 104, while it is being displayed on the TV 102. FIG. 18 embodies the scenario illustrated in FIG. 10a and where a full fledged video is displayed on the TV 102, as the alternative video content, with the provision for the automated timer control. The TV 102 or the STB 106 is capable of running the timer. The user browses through the settings of the device and turns on the timer associated with the control of unsuitable video content. The user also sets the timer value 302. On perceiving unsuitable video content, the user presses the dedicated button 202 on the remote controller of the TV 102, wherein an interrupt event 204 is sent to the master application on the TV 102. The master application responds to the event 204 by muting 206 the audio. The master application then transfers 802 an encoded video to a video codec. The video decoder renders 804 the decoded video on the TV 102. If the STB was recording the original video content, then it continues to demux, decode, encode, mux and write 1102 the original video stream to a storage device. The display of the alternative video continues till the dedicated button 202 is pressed a second time on the remote controller of the TV 102 or the timer 302 expires, wherein an interrupt event 210 is sent to the master application on the TV 102. The master application responds to 210 by clearing the timer display, unmuting 212 the audio and terminating the display of the alternative video 806 on the TV 102. At this point, the original video stream, format least one of the antenna 104 and the STB 106 resumes on the TV 102.

FIG. 18 also subsumes the scenario illustrated in FIG. 10b as well as FIG. 10c and where the full fledged video and timer are generated by the STB 206. The method is commenced with the remote controller of the STB 106. In this case, the master application that responds to all events, such as the pressing of the dedicated button 202 and responding to event 204, is resident on the STB 106. All the actions, such as muting the audio 206 and unmuting the audio 212, described in the above paragraph are performed by the master application on the STB 106.

FIG. 18 also subsumes the scenarios illustrated in FIG. 10c as well as FIG. 10d and where the full fledged video and timer are generated by the active display unit, such as the SmartTV 108. The method is commenced with the remote controller of the SmartTV 108. In this case, the master application that responds to all events, such as the pressing of the dedicated button 202 and responding to event 204, is resident on the SmartTV 108. All the actions, such as muting the audio 206 and unmuting the audio 212, described in the above paragraph are performed by the master application on the SmartTV 108.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of controlling a display of an unsuitable video content in an original video content, wherein the original video content subsumes an audio content associated with the original video content, the method comprising:
detecting an unsuitable video content by a user,
pressing a dedicated button on a remote controller of a device supporting a control of the display,
wherein the device supporting the control of the display replaces the unsuitable video content with an alternative video content; and
pressing the dedicated button on the remote controller of the device controlling the display, to resume the original video content.

2. The method as claimed in claim 1, wherein the unsuitable video content is at least one of adult content, violent content or an objectionable content as perceived by a user.

3. The method as claimed in claim 1, wherein the unsuitable video content as perceived by a user is not codifiable.

4. The method as claimed in claim 1, wherein the alternative video content is at least one of a blank screen, a still image, an animation, and a video of a user's choice.

5. The method as claimed in claim 1, wherein the alternative content is pre-programmed into the device controlling the display.

6. The method as claimed in claim 1, wherein the alternative content may be pre-programmed into the device controlling the display, by the user.

7. The method as claimed in claim 1, wherein the alternative content to be displayed is configured through the setting of an operational parameter of a device controlling the display, by an On Screen Display.

8. The method as claimed in claim 1, wherein duration of display of the alternative content is configured through a setting of the device controlling the display.

9. The method as claimed in claim 1, wherein the device controlling the display includes a passive display device, wherein the passive display device comprises a TV or monitor.

10. The method as claimed in claim 1, wherein the device controlling the display includes a smart display device, wherein the smart display device comprises a SmartTV.

11. The method as claimed in claim 1, wherein the device controlling the display is at least one of a Set Top Box or an accessory.

12. The method as claimed in claim 1, wherein the method includes:
determining whether the original video content is recording continuously, and
continuing recording the original video content irrespective of the alternative video content being displayed on the display device.
